(19) United States
(12) Patent Application Publication
(10) Pub. No.: US 2023/0334517 A1
(43) Pub. Date: Oct. 19, 2023

(54) System and Method for Consumer Choice Modeling

(71) Applicant: DIG Insights Inc., Toronto (CA)

(72) Inventors: Joel Gregory ANDERSON, Toronto (CA); Ian ASH, Aurora (CA)

(21) Appl. No.: 18/336,647

(22) Filed: Jun. 16, 2023

Related U.S. Application Data
(63) Continuation of application No. PCT/CA2021/051843, filed on Dec. 17, 2021.
(60) Provisional application No. 63/127,920, filed on Dec. 18, 2020.

(51) Int. Cl. G06Q 30/0203

(52) U.S. Cl. CPC G06Q 30/0203

(57) ABSTRACT

Method and system for automating market research analysis of choice experiments such as by generating a discrete choice design, implementing discrete choice modeling, and presenting resulting choice models and insights to a client using an integrated platform. The system of the present disclosure can include a platform which may provide an environment in which clients, respondents, administrators, and other parties can access data and information necessary to conduct analysis and generate choice models and insights. The platform may include a data modeling module, configured to run statistical analysis, that can access choice data and carry out parallelized statistical modeling thereof to accelerate generation of choice models and insights such that they can be viewed by the client via the platform shortly after or nearly immediately after initiation of data analysis.

### CROSS-REFERENCE TO RELATED APPLICATIONS

The present application is a continuation of International PCT Application No. PCT/CA2021/051843 filed Dec. 17, 2021, which claims priority from U.S. Provisional Application No. 63/127,920 filed Dec. 18, 2020, both of which are incorporated herein by reference in their entireties.

### TECHNICAL FIELD

The following relates to choice modeling for consumer product manufacturers and/or consumer store and retail chains, and more particularly to a system and method for discrete choice modeling.

### BACKGROUND

Choice models are an important component of several retail decision-support applications used by various entities in a retail supply chain including consumer product manufacturers and/or consumer retail chains and individual retail stores. Some examples of retail applications that require accurate choice models for individual products, or for entire retail categories, include, for instance, inventory optimization, product pricing, product-line rationalization, new product innovation, and promotion planning.

To address shortcomings of older methods of choice modeling, such as use of focus groups and directly asking purchase intent in surveys, the field of discrete choice analysis was created. Generally, discrete choice analysis techniques attempt to quantify a respondent's preference for attributes and attribute levels of a particular product. Such quantification is intended to allow a manufacturer or retailer to compare the attractiveness to a respondent of various product configurations. Accordingly, the relative attractiveness of any attribute or attribute level with respect to any other attribute or attribute level can often be determined simply by comparing the appropriate associated numerical values. The importance or influence contributed by the component parts, e.g., product attributes, can be measured in relative units referred to as “utilities” or “utility weights”.

In some cases, the utilities are measured indirectly, such as by respondents being asked to consider alternatives and/or to state a likelihood of purchase or preference for each alternative. As the respondents continue to make choices, a pattern begins to emerge which, through techniques including, but not limited to, complex multiple regression, can be broken down and analyzed as to the individual features that contribute most to the purchase likelihood or preference. In other cases, respondents may be asked to tell the interviewer directly how important various product features are to them. For example, they may be asked to rate on a scale of 1 to 100 various product features. Respondents may also be guided through complex virtual shopping trips, and may need to choose between a number of products at each screen.

Additionally, while many advancements have been made in improving the accuracy of choice modeling, it is often the case that choice modeling methods, such as those having a hierarchical Bayesian multinomial logit model basis, suffer from slow data processing speed, since they employ computationally intensive statistical methods, such as Markov chain Monte Carlo (“MCMC”) sampling. Slow processing times may disadvantageously create a considerable delay between the start of data analysis (by, e.g., a market researcher) and when a client is presented with the desired choice models and insights.

There is demand in the market research industry for ever faster, on demand, dashboard results. Without new modeling methods and automation, the traditional, tabulated results based on non-modeled data are available immediately to clients, but they need to wait days to receive the full modeled results and their associated insights.

In view of the foregoing, it is recognized that there exists a need for improved consumer choice modeling methods and systems.

### SUMMARY

In one aspect, provided is a system for automating the integration of collection of choice data, choice modeling analysis of the choice data, and presentation of choice modeling insights generated by the choice modeling analysis, the system comprising: at least one computing device configured to provide a computing platform, the computing platform comprising: at least one client module providing an interface for communicating with one or more client devices, at least one client module being configured to present data insights to the client; at least one respondent module providing an interface for communicating with one or more respondent devices, at least one respondent module being configured to run one or more choice exercises and output choice data; and a data modeling module configured to run in real time statistical analysis for choice modeling of the choice data to output one or more data insights, the data insights comprising one or more of: share of choice output and/or simulator, source of volume output and/or simulator, Total Unduplicated Reach and Frequency output and/or simulator, and network mapping visualizations; and a database for storing the choice data and choice model output and data insights, the database being accessible by the data modeling module.

In an implementation, the platform has access to a processor having multiple cores and the data modeling module is configured to run parallelized statistical analysis by the multiple cores.

In another implementation, the platform has access to a graphics processing unit (GPU), and the data modeling module is configured to run parallelized statistical analysis by the GPU.

In yet another implementation, the statistical analysis is carried out at least in part by execution of a parallelized statistical analysis script.

In yet another implementation, the database is accessible by an integration layer interposed between the computing platform and the database.

In yet another implementation, the database is accessible by an API included in the computing platform.

In yet another implementation, the system further comprises an administrator module providing an interface for communicating with administrator devices.

In yet another implementation, the one or more client modules are further configured to receive a product list from at least one of the client devices.

In yet another implementation, the one or more respondent modules are further configured to receive the product list from the one or more client modules and to generate a choice exercise for outputting choice data specific to the product list.

In yet another implementation, the data insights are specific to the product list.

In yet another implementation, the platform is further configured to automatically generate the one or more choice exercises based on the product list.

In yet another implementation, the one or more choice exercises are configured to be run on computing devices having touch screen functionality.

In yet another implementation, at least one of the choice exercises comprises a single elimination bracket of products in the product list.

In yet another implementation, the respondent module is configured to display, by a graphical user interface displayed on the respondent device through an application or web page, a description or image of at least one product and to prompt the respondent to select whether they like or dislike the at least one product.

In yet another implementation, the selecting is done by swiping the description or image of the product in one of two opposing directions on the graphical user interface and/or selecting yes or no on the graphical user interface.

In yet another implementation, the respondent module is further configured to simultaneously display, by a graphical user interface on the respondent device, a description or image of two or more alternative products and to prompt the respondent to select a preferred product of the two or more alternative products.

In another aspect, provided is a method for the integration of collection of choice data, choice modeling analysis of the choice data, and presentation of choice modeling insights generated by the choice modeling analysis, the method comprising: providing at least one computing device configured to provide a computing platform, the computing platform comprising: at least one client module providing an interface for communicating with one or more client devices, at least one client module being configured to present data insights to the client; at least one respondent module providing an interface for communicating with one or more respondent devices, at least one respondent module being configured to run one or more choice exercises and output choice data; and a data modeling module configured to run in real time statistical analysis for choice modeling of the choice data to output one or more data insights, the data insights comprising one or more of: share of choice output and/or simulator, source of volume output and/or simulator, Total Unduplicated Reach and Frequency output and/or simulator, and network mapping visualizations; and a database for storing the choice data and choice model output and data insights, the database being accessible by the data modeling module.

In an implementation, the platform has access to a processor having multiple cores and the data modeling module is configured to run parallelized statistical analysis by the multiple cores.

In another implementation, the platform has access to a graphics processing unit (GPU), and the data modeling module is configured to run parallelized statistical analysis by the GPU.

In yet another implementation, the statistical analysis is carried out at least in part by execution of a parallelized statistical analysis script.

In yet another implementation, the database is accessible by an integration layer interposed between the computing platform and the database.

In yet another implementation, the database is accessible by an API included in the computing platform.

In yet another implementation, the method further comprises providing an administrator module providing an interface for communicating with administrator devices.

In yet another implementation, one or more client modules are further configured to receive a product list from at least one of the client devices.

In yet another implementation, the one or more respondent modules are further configured to receive the product list from the one or more client modules and to generate a choice exercise for outputting choice data specific to the product list.

In yet another implementation, the data insights are specific to the product list.

In yet another implementation, the platform is further configured to automatically generate the one or more choice exercises based on the product list.

In yet another implementation, the one or more choice exercises are configured to be run on computing devices having touch screen functionality.

In yet another implementation, at least one of the choice exercises comprises a single elimination bracket of products in the product list.

In yet another implementation, the respondent module is configured to display, by a graphical user interface displayed on the respondent device through an application or web page, a description or image of at least one product and to prompt the respondent to select whether they like or dislike the at least one product.

In yet another implementation, the selecting is done by swiping the description or image of the product in one of two opposing directions on the graphical user interface and/or selecting yes or no on the graphical user interface.

In yet another implementation, the respondent module is further configured to simultaneously display, by a graphical user interface on the respondent device, a description or image of two or more alternative products and to prompt the respondent to select a preferred product of the two or more alternative products.

In yet another aspect, there is provided a system for automating the integration of choice exercise design, collection of choice data via a “mobile-first” swiping exercise, choice modeling of the choice data, and presentation of choice modeling insights generated by the choice modeling, the system comprising: at least one computing device configured to provide a computing platform, the computing platform comprising: at least one client module providing an interface for communicating with client devices, the at least one client module being configured to present data insights to the client; at least one respondent module providing an interface for communicating with respondent devices, the at least one respondent module being configured to run one or more choice exercises and output choice data; and a data modeling module configured to run statistical analysis for choice modeling of the choice data to output one or more data insights, the data insights comprising one or more of: share of choice output and/or simulator, source of volume output and/or simulator, “TURF” output and/or simulator, and network mapping visualizations; and the system further comprising a database for storing the choice data, choice model output and data insights, the database being accessible by the data analysis module and data insights layer.

In an implementation, the platform has access to a processor having multiple cores and the statistical analysis software is configured to be run in parallel by the multiple cores.

In another implementation, the platform has access to a graphics processing unit (GPU), and the statistical analysis software is configured to be run in parallel by the GPU.

In yet another implementation, the database is accessible by an integration layer interposed between the computing platform and the database.

In yet another implementation, the database is accessible by an API included in the computing platform.

In yet another implementation, the system further comprises an administrator module providing an interface for communicating with advisor devices.

In yet another implementation, the one or more client modules are further configured to receive a product list from at least one of the client devices.

In yet another implementation, the one or more respondent modules are further configured to receive the product list from the one or more client modules and to generate a choice exercise for outputting choice data specific to the product list.

In yet another implementation, the data insights are specific to the product list.

### BRIEF DESCRIPTION OF THE DRAWINGS

Embodiments will now be described with reference to the appended drawings wherein:

FIG. 1 is a schematic block diagram of a prior art system for collection and modeling of consumer choice data.

FIG. 2 is flow chart illustrating a prior art method for collection and modeling of consumer choice data using the system shown in FIG. 1.

FIG. 3 is a schematic block diagram of a system for choice modeling including a platform that can be used for carrying out respondent surveys to obtain choice modeling data, automatically conduct statistical choice modeling techniques of the resulting consumer choice data, and generate insights that can be viewed in real time by a client, via the platform.

FIG. 4 a flow chart illustrating a method for operating the system of FIG. 3 to conduct choice modeling and present models and insights to clients shortly after or nearly immediately after initiation of data analysis.

FIG. 5 is a flow chart illustrating a basic method of conducting a respondent survey to obtain choice data for discrete choice modeling.

FIG. 6 is a screen shot of an example of a respondent user interface during a respondent survey carried out according to the method of FIG. 5.

FIG. 7 is a further screen shot of an example of a respondent user interface during a respondent survey carried out according to the method of FIG. 5.

FIG. 8 is a further screen shot of an example of a respondent user interface during a respondent survey carried out according to the method of FIG. 5.

### DETAILED DESCRIPTION

Provided herein is a method and system for carrying out consumer choice modeling, such as by implementing discrete choice analysis, and presenting resulting choice models and insights to a client using an integrated platform. The system and method described herein may enable clients (e.g., retail companies or product manufacturers) and respondents to electronically and remotely initiate and participate in, respectively, choice modeling to generate insights that the clients can use to make business decisions.

The system of the present disclosure can include a platform which may provide an environment in which clients, such as retail corporations, respondents, administrators, and other parties can access data and information necessary to conduct analyses and generate choice models and insights such as those described herein. As explained in greater detail below, the platform may include a data modeling module that can access choice data and carry out parallelized statistical modeling thereof to accelerate generation of choice models and insights such that they can be viewed by the client via the platform shortly after or nearly immediately after initiation of data analysis. The data modeling module may be referred to herein as a “statistical modeling module”. The platform may optionally include an additional data analysis module for conducting basic preliminary data analysis and/or preparation before choice modeling.

In some embodiments, the platform can be configured to present respondents with a simplified choice survey which can be created automatically by the platform (i.e., without or with minimal intervention by an administrator). This may advantageously provide the client with more control over the process of initiating and receiving the results of a choice modeling request. For example, the client may upload a list containing products, ideas, or features of interest within a given category, and the platform may automatically create a survey that is instantaneously, nearly instantaneously, or shortly accessible by respondents. This may reduce or obviate the need for experimental design generation on a case-by-case basis by an administrator (e.g., a market researcher) which can be inefficient and can lead to delays.

Common choice modeling methods include, but are not limited to, conjoint, discrete choice, and self-explicated. Conjoint analysis requires respondents to consider ideas or products independently of one another. Conjoint analysis may reveal consumer preferences of product features and identify the trade-offs consumers are willing to make. Conversely, in discrete choice, respondents simultaneously consider a set of profiles (e.g., a set of products or ideas) and select the one they are most likely to purchase (if any). Self-explicated analysis, unlike conjoint and discrete choice analyses, determines respondents' utilities directly by asking respondents to explicitly state how important all attributes/features are to their purchase interest.

While the following description discusses the implementation of an analysis technique that may fit into the discrete choice category, other types of choice modeling methods may be conducted by the system of the present disclosure. The systems and methods of the present disclosure may be particularly beneficial for choice modeling analysis techniques that tend to be computationally intensive, such as hierarchical Bayesian methods that generate respondent-specific coefficients using MCMC methods. Hierarchical Bayesian models are known to be important for this application of discrete choice analysis because respondent-specific coefficients may drastically reduce the independence of irrelevant alternatives (IIA) problem of multinomial logit models, an issue which may reduce the accuracy of results if not handled appropriately.

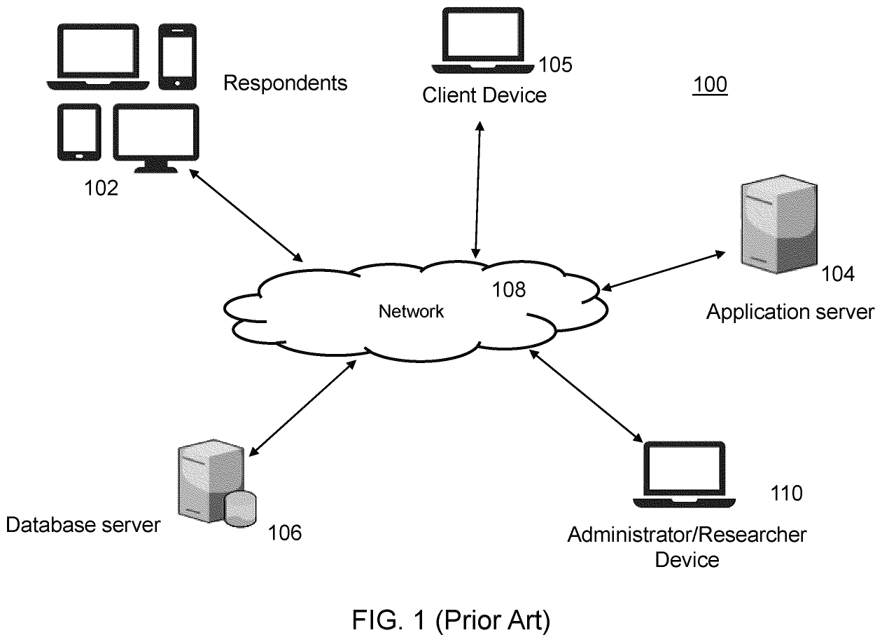

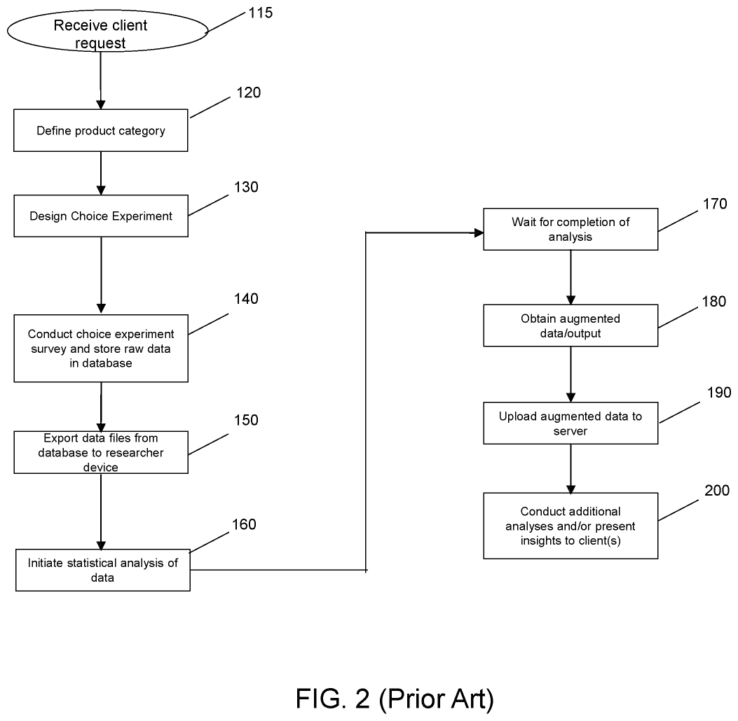

FIG. 1 schematically illustrates a prior art choice modeling system 100. The prior art system includes respondent devices 102, one or more servers 104, one or more databases 106 (e.g., database servers), and an administrator device 110, which are communicatively coupled via a network 108. The administrator may be, for example, a market research company. The prior art choice modeling system 100 may operate as shown by the flow chart illustrated in FIG. 2. FIG. 2 illustrates a typical method of providing choice modeling insights to clients, such as retail companies. The method can be carried out by the system 100 and can be initiated by receiving a request from a client (step 115). Subsequently, a product category (step 120) can be defined, and a choice experiment designed (step 130). Next, the choice experiment can be conducted (step 140), i.e., completed by the respondents, and the resulting choice data may be stored in the database 106. At step 150, choice data stored in the database can be retrieved by the administrator device 110 which can initiate and conduct statistical modeling of the data (step 160). At step 170, there may be a period of processing time such as, for example, 30 minutes to several hours or days, during which statistical modeling is run. Once the modeling is completed the augmented data can be obtained (step 180) and uploaded via the network (step 190) to the server 104 for visualization by the client (step 200). The delay caused by slow data modeling can, in turn, lead to longer than desired data insight delivery times (i.e., time between steps 115 and 200). Additionally, the choice experiment design step 130 may require direct participation by the administrator, particularly a statistical analyst, and can further delay delivery of data insights.

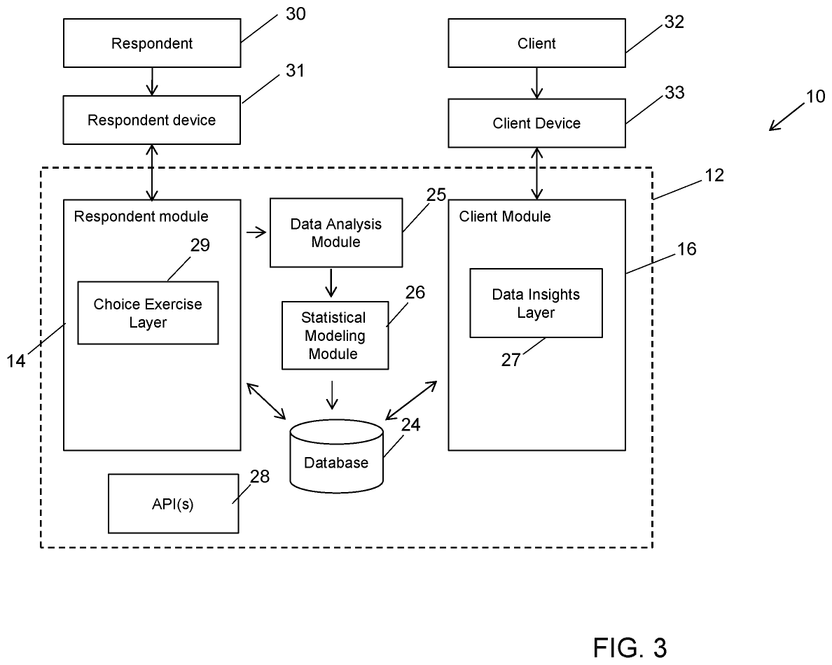

FIG. 3 schematically illustrates a choice modeling system 10 that may address one or more of the above drawbacks. The system 10 may include at least one computing device such as a server to provide a choice modeling platform 12. The platform 12 can provide an environment in which clients, such as retail corporations, respondents, administrators, and other parties can access data and information necessary to conduct the analyses and generate and view choice models and insights such as those described herein. The integrated platform 12, which may leverage parallel computing and/or, after receiving a product list from a client, automatically generate choice experiment surveys for completion by respondents, may enable the generation of choice models and insights considerably more quickly than the prior art system 100. In contrast to the system 100, due to the automatic generation of the choice experiments, the system may not require a statistical analyst to spend time designing choice experiments.

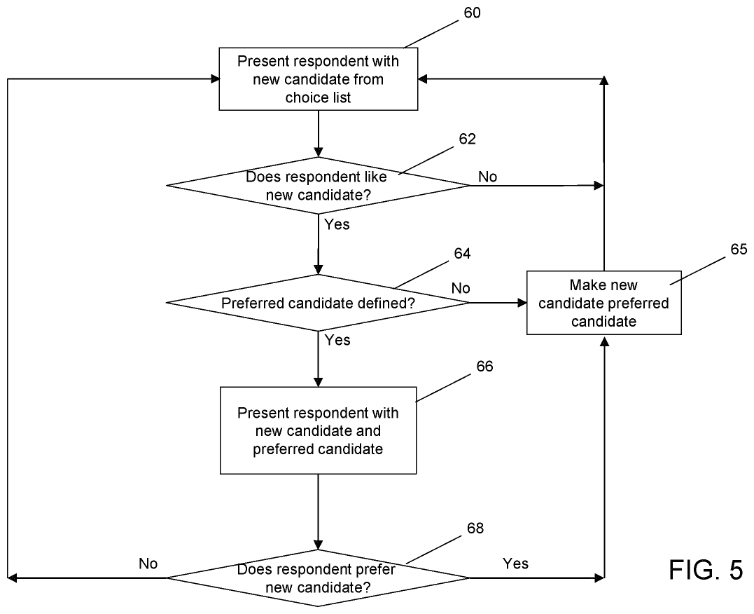

In the example embodiment shown in FIG. 3, the platform 12 comprises a respondent module 14 and a client module 16. The respondent module 14 may include a choice exercise layer 29 which can collect data (e.g., results of choice exercises as described with reference to FIG. 5) from respondents 30 via one or more respondent devices 31. The platform 12 can include a database 24 that can store choice data obtained by the choice exercise layer 29. The platform 12 can further include a data analysis module 25 and a statistical modeling module 26. The data analysis module 25 may be communicatively coupled to the choice exercise layer 29 to receive choice data therefrom and may perform preliminary transformation and/or basic analysis of the data prior to the modeling of the data at the statistical modeling module 26. In some embodiments, the data analysis module 25 may not be needed and the choice exercise layer 29 may communicate directly with the statistical modeling module 26 which may access statistical analysis computer code/scripts, stored on or external to the platform 12. In some embodiments, the computer code/scripts may be part of statistical analysis software accessible by the platform 12.

Optionally, the system may include external databases or external database servers for storing choice data and the platform 12 may be in communication with an integration layer and/or various APIs which can enable the platform 12 to obtain, or obtain access to, choice data collected during a choice experiment, or survey. The system 10 may be configured in alternative ways, or having different data architecture structures, to provide the platform 12 with access to the database 24 and/or one or more external databases or database servers. The platform 12 may include one or more APIs 28 to suitably communicatively couple components of the platform 12.

The client module 16 may include a data insights layer 27 for receiving augmented data from the statistical modeling module 26 and automatically generating data insights that can be visualized by the client 32 via a client device 33. Data insights that can be presented to and visualized by the client may include, but are not limited to, Total Unduplicated Reach and Frequency (“TURF”) simulations, share of choice simulations, source of volume simulations, and network map visualizations.

Optionally, an administrator module (not shown) can be suitably communicatively coupled to the data analysis module 25 and data insights layer 27 such that an administrator can oversee data processing and demand insight generation.

The system 10 may be accessed using any suitable medium that enables user interactivity with a corresponding module within the platform 12, such as an app or web browser. Herein an exemplary medium is a user interface (UI) provided by way of a web browser and can be integrated with or otherwise communicable with one or more server-sided entities or services that enable provision, dissemination, tracking, and communications within a platform or system level environment.

The components within the platform 12 in FIG. 3 are shown in isolation for ease of illustration, but may include suitable communication connections therebetween, such as those discussed herein and others that are not discussed herein.

The statistical analysis computer code or software may be configured to conduct choice modeling in parallel, i.e., the statistical analysis computer code or software may include a parallelized script that can be run using parallel computing. The platform 12 may include a multi-core processor (not shown) or a graphics processing unit (GPU) (not shown), enabling local parallelization of the statistical modeling. Preferably, the parallelized script is configured to be executed by a GPU. Parallelized statistical modeling of the data may be carried out on local and/or remote computing devices (not shown) including one or more multi-core processors or GPUs. In this example embodiment, the statistical method is a parallelized MCMC technique for discrete choice modeling configured to be executed by a GPU or AI accelerator (hardware accelerated machine learning system). In other example embodiments, the statistical method may include Hamiltonian Monte Carlo (HMC) or No-U-Turn Sampling (NUTS). Other choice models that can benefit from or that require computationally intensive statistical modeling techniques, such as MCMC, can benefit from parallelization as described above. Any suitable parallel computing platform and programming model may be used to leverage GPUs for execution of the parallelizable statistical computation. For example, CUDA™ may be used in combination with NVIDIA™ GPUs.

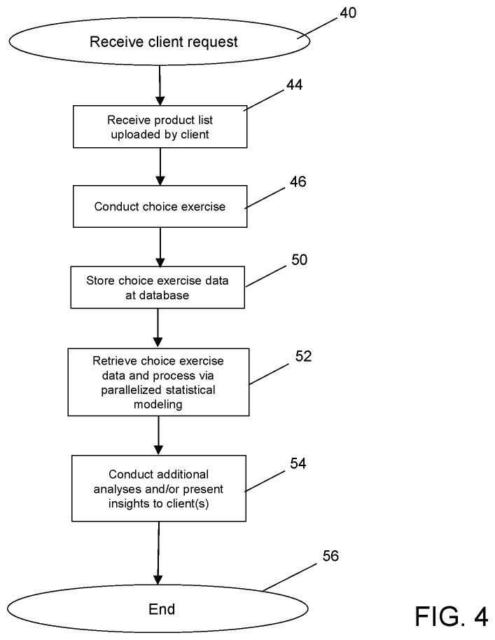

FIG. 4 is a flow chart illustrating an example embodiment of a general method for modeling consumer choice preference. The method may be carried out using the system 10 shown in FIG. 3. The method can be initiated by receiving a request from a client 32 (step 40). Next, at step 44, the client 32 can upload a product list within a given product category. At step, 44, the platform may automatically generate the choice exercise. Optionally, an administrator can step in and design a choice experiment. Next, at step 46, the choice exercise can be conducted, i.e., completed by the respondents 30. The consumer choice data can be stored in the database 24 (step 50) throughout step 46, or may be stored elsewhere throughout step 46 and then sent to the database (step 50). Next, choice exercise data can be retrieved by the statistical modeling module 26 which can conduct choice modeling using parallelized statistical modeling (step 52). Optionally, the choice exercise data can be pre-processed by the data analysis module 25 between steps 50 and 52. The resulting augmented, or choice model data can be received by the data insights layer 27 (which can present the desired data insight(s) to the client 32 (step 54). The method can subsequently end (step 56) and may re-start at step 40 when another client request is received.

Parallel processing may considerably accelerate the choice modeling process, and thus enable automation of the analysis and preferably enable near real-time choice modeling and insight generation. In some example embodiments, the client may be able to visualize the desired choice models and insights shortly after respondents have completed the desired choice experiment or survey. In other embodiments, it may be that the client can receive and visualize the generated choice models nearly in real-time following the completion of the respondent survey.

In some example embodiments of the platform and method, discrete choice analysis can be utilized to generate choice models. Generally, according to discrete choice analysis, a respondent is presented with a set of product configurations and asked to select either the configuration that the respondent is most interested in purchasing or no configuration if the respondent is not interested in purchasing any of the presented configurations. The process may then be repeated for other sets of product configurations.

An example embodiment of a method for conducting a survey or choice experiment for discrete choice modeling is shown in FIG. 5. To initiate such method, the client 32 may upload a product list to the platform 12 and the choice exercise layer 29 can automatically generate a choice exercise that employs, for example, the method illustrated in FIG. 5. While the method shown in FIG. 5 may be considered simple relative to existing methods (and thus facilitates automated survey generation), it was found that the choice modeling results of such method correlate highly with the results obtained from choice modeling using results from more complex surveys when specifying the model and tuning the priors appropriately. Thus, in addition to providing accurate results, use of the choice exercise of the present disclosure, and variations of such exercise, may enable automatic survey and experiment design generation by, e.g., the platform 12 after receiving a product list from the client 32, and may thereby accelerate choice modeling. Additionally, the systems and methods of the present disclosure may ease the burden on respondents by providing choice experiments that may be easier to complete on smaller computing devices (e.g., mobile phones) as compared to existing choice experiments.

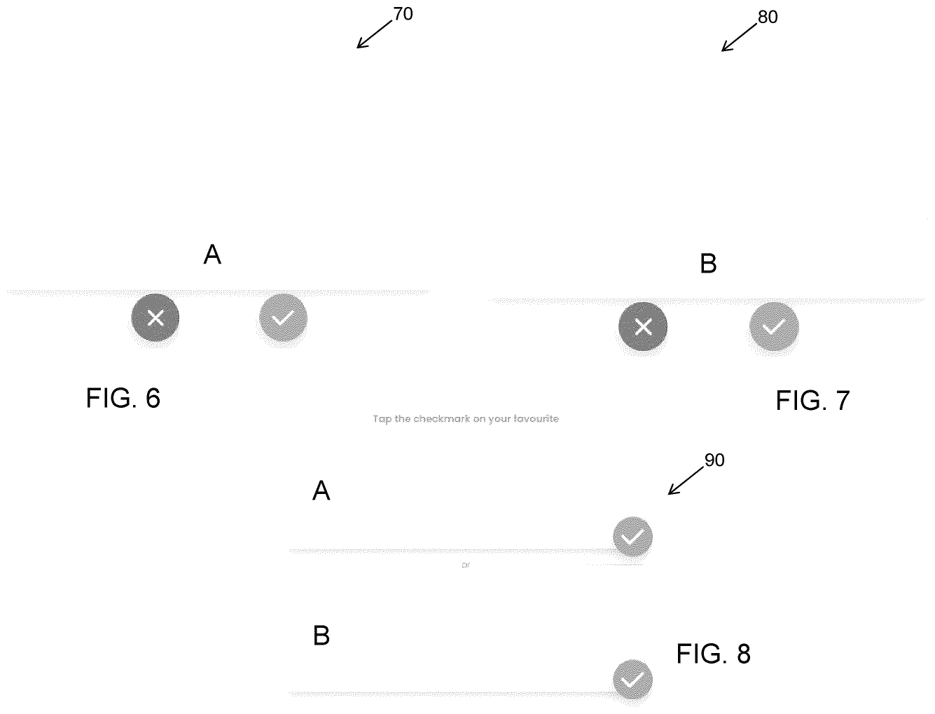

Several graphical user interface (GUI) pages may be used to guide the respondent 30 through a choice exercise employing, e.g., the method illustrated in FIG. 5, in order to generate data to be used for choice model. FIGS. 6-8 illustrate exemplary screenshots of example embodiments of such GUI pages which may guide the respondents 30 through the choice experiment. It will be understood that differently designed GUI pages may be used to guide the respondents through the choice experiments.

Continuing with FIG. 5, the method can begin at step 60, where the respondent 30 may be presented with a new candidate (i.e., product) from a product choice list which may be uploaded to the platform 12 by the client 32. Next, the respondent 30 may be prompted to choose whether they like the new candidate (step 62). FIG. 6 illustrates an example of steps 60 and 62 wherein the respondent 30 is presented with a new candidate (product A) and prompted to decide whether they like product A. In this example embodiment, the respondent 30 indicates that they like product A by clicking the check mark icon. If the respondent did not like product A, the respondent 30 could alternatively click the “X” icon. The product A is, in this example embodiment, the first product presented to the respondent 30 and belongs to a list of several products uploaded to the platform 12 by the client 32.

As mentioned, at step 62, the respondent 30 indicated that they like product A (graphical user interface 70, FIG. 6). Since product A is the first product presented to the respondent 30, the answer at the subsequent step (64) is no. Product A thus can be made the preferred candidate (step 65). Subsequently, step 60 can be repeated, and the respondent can be presented with a new product, as illustrated by graphical user interface 80 of FIG. 7 where product B is the new product. In this example embodiment, the respondent indicates at step 62 that they like the new candidate (product B) and, since the preferred candidate (product A) is defined (step 64), the method may proceed to step 66 where the respondent 30 can be prompted to choose between products A and B (see graphical user interface 90, FIG. 8). The method can then repeat directly at step 60 or via step 65 depending on whether the respondent prefers product B over product A (step 68). The method can be repeated until each product in the list has been reviewed. When the method is complete, the results can be used for choice modeling as discussed above.

The method steps of the present disclosure may be embodied in sets of executable machine code stored in a variety of formats such as object code or source code. Such code is described generically herein as computer code for simplification. The executable machine code or portions of the code may be integrated with the code of other programs, implemented as subroutines, plug-ins, add-ons, software agents, by external program calls, in firmware or by other techniques as known in the art.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both.

Although the above principles have been described with reference to certain specific examples, various modifications thereof will be apparent to those skilled in the art as outlined in the appended claims.

1. A system for automating the integration of collection of choice data, choice modeling analysis of the choice data, and presentation of choice modeling insights generated by the choice modeling analysis, the system comprising:
at least one computing device configured to provide a computing platform, the computing platform comprising:
at least one client module providing an interface for communicating with one or more client devices, at least one client module being configured to present data insights to the client;
at least one respondent module providing an interface for communicating with one or more respondent devices, at least one respondent module being configured to run one or more choice exercises and output choice data;
and
a data modeling module configured to run in real time statistical analysis for choice modeling of the choice data to output one or more data insights, the data insights comprising one or more of: share of choice output and/or simulator, source of volume output and/or simulator, Total Unduplicated Reach and Frequency output and/or simulator, and network mapping visualizations; and
a database for storing the choice data and choice model output and data insights, the database being accessible by the data modeling module.

2. The system of claim 1, wherein:
the platform has access to a processor having multiple cores and the data modeling module is configured to run parallelized statistical analysis by the multiple cores; or
the platform has access to a graphics processing unit (GPU), and the data modeling module is configured to run parallelized statistical analysis by the GPU.

3. The system of claim 1, wherein the one or more client modules are further configured to receive a product list from at least one of the client devices.

4. The system of claim 3, wherein the one or more respondent modules are further configured to receive the product list from the one or more client modules and to generate a choice exercise for outputting choice data specific to the product list.

5. The system of claim 4, wherein the data insights are specific to the product list and/or the platform is further configured to automatically generate the one or more choice exercises based on the product list.

6. The system of claim 4, wherein:
the one or more choice exercises are configured to be run on computing devices having touch screen functionality; and/or
at least one of the choice exercises comprises a single elimination bracket of products in the product list.

7. The system of claim 4, wherein the respondent module is configured to display, by a graphical user interface displayed on the respondent device through an application or web page, a description or image of at least one product and to prompt the respondent to select whether they like or dislike the at least one product.

8. The system of claim 7, wherein the selecting is done by swiping the description or image of the product in one of two opposing directions on the graphical user interface and/or selecting yes or no on the graphical user interface.

9. The system of claim 8, wherein the respondent module is further configured to simultaneously display, by a graphical user interface on the respondent device, a description or image of two or more alternative products and to prompt the respondent to select a preferred product of the two or more alternative products.

10. A method for automating the integration of collection of choice data, choice modeling analysis of the choice data, and presentation of choice modeling insights generated by the choice modeling analysis, the method comprising:
providing at least one computing device configured to provide a computing platform, the computing platform comprising:
at least one client module providing an interface for communicating with one or more client devices, at least one client module being configured to present data insights to the client;
at least one respondent module providing an interface for communicating with one or more respondent devices, at least one respondent module being configured to run one or more choice exercises and output choice data;
and
a data modeling module configured to run in real time statistical analysis for choice modeling of the choice data to output one or more data insights, the data insights comprising one or more of: share of choice output and/or simulator, source of volume output and/or simulator, Total Unduplicated Reach and Frequency output and/or simulator, and network mapping visualizations; and
a database for storing the choice data and choice model output and data insights, the database being accessible by the data modeling module.

11. The method of claim 10, wherein:
the platform has access to a processor having multiple cores and the data modeling module is configured to run parallelized statistical analysis by the multiple cores; or
the platform has access to a graphics processing unit (GPU), and the data modeling module is configured to run parallelized statistical analysis by the GPU.

12. The method of claim 10, wherein the one or more client modules are further configured to receive a product list from at least one of the client devices, and the one or more respondent modules are further configured to receive the product list from the one or more client modules and to generate a choice exercise for outputting choice data specific to the product list.

13. The method of claim 12, wherein the data insights are specific to the product list.

14. The method of claim 12, wherein the platform is further configured to automatically generate the one or more choice exercises based on the product list.

15. The method of claim 12, wherein the one or more choice exercises are configured to be run on computing devices having touch screen functionality.

16. The method of claim 12, wherein at least one of the choice exercises comprises a single elimination bracket of products in the product list.

17. The method of claim 12, wherein the respondent module is configured to display, by a graphical user interface displayed on the respondent device through an application or web page, a description or image of at least one product and to prompt the respondent to select whether they like or dislike the at least one product.

18. The method of claim 17, wherein the selecting is done by swiping the description or image of the product in one of two opposing directions on the graphical user interface and/or selecting yes or no on the graphical user interface.

19. The method of claim 18, wherein the respondent module is further configured to simultaneously display, by a graphical user interface on the respondent device, a description or image of two or more alternative products and to prompt the respondent to select a preferred product of the two or more alternative products.
